(19) United States
(12) Patent Application Publication
(10) Pub. No.: US 2002/0139119 A1
(43) Pub. Date: Oct. 3, 2002

(54) Combustor with inlet temperature control

(76) Inventors: George L. Touchton, Newark, CA (US); Robert W. Dibble, Livermore, CA (US); John Torres, Hayward, CA (US)

Correspondence Address: James W. Peterson, Esq., BURNS, DOANE, SWECKER & MATHIS, L.L.P., P.O.Box 1404, Alexandria, VA, 22313-1404, US

(21) Appl. No.: 09/822,290

(22) Filed: Apr. 2, 2001

(51) Int. Cl. F02C 7/10

(52) U.S. Cl. 60/772; 60/39.511

(57) ABSTRACT

An energy-generating system employs a combustor to combust a pressurized fluid, with the resulting products of combustion being used to operate a turbine. The pressurized fluid is divided into first and second fluid portions that are conducted to the combustor inlet through first and second flow paths, respectively. The second flow path is arranged to cause the second fluid portion traveling therein to receive heat from the combustor before being merged with the first fluid flow at the combustor inlet. The combustor can include catalytic bodies, and some products of combustion generated in the combustion chamber are recycled back through the combustor.

### BACKGROUND OF THE INVENTION

The present invention relates to combustors which convert the chemical energy of a fuel, such as natural gas in the presence of an oxidizer, into heat energy and burned products.

Self-contained energy centers or cogeneration systems have been proposed, wherein chemical fuel is combined with compressed air from a compressor and is combusted. The resulting hot, high pressure gas drives a turbine which powers the compressor as well as electrical generating equipment. There are thus provided mechanical energy, electrical energy, and heat energy (i.e., waste heat from the turbine) which can be utilized to satisfy various needs such as heating, cooling, ventilating, lighting, etc., in a building.

Such a system is disclosed, for example, in U.S. Pat. No. 6,107,693, the disclosure of which is incorporated by reference herein. In that system, fuel and air are delivered to a compressor which compresses and outputs the mixture to the cold side of a heat exchanger in which it becomes heated. The heated, high-pressure mixture is then delivered to a combustor, and the resulting products of combustion are directed to the inlet of at least one expansion turbine of a turbine mechanism. After powering the turbine mechanism, the hot combustion gases are directed through the hot side of the heat exchanger. Accordingly, heat from those gases is transferred to the cooler air/fuel mixture passing through the cold side of the heat exchanger. The hot combustion gases exiting the hot side of the heat exchanger may then be delivered to heat-utilizing devices such as a hot water heater. Meanwhile, the turbine mechanism drives the compressor, as well as an electric generator for producing electric power.

The present invention pertains to the combustor, whose function is to supply heat energy to a thermodynamic cycle, process, or other device which can then be converted to electrical, mechanical, or potential energy, used directly for heating, drying, and the like, or employed in other ways. In order to perform its function, the combustor must fit into the process or cycle for which it is intended. That is, it is necessary to adapt or match the demands of the combustor with the requirements of the cycle. A specific problem for the continuous Brayton cycle engine, for example, involves adapting the combustor to the range of combustor inlet temperatures produced by the engine in operation. Typically, the compressors and turbines are rotating devices whose pressure, temperature, and air flow characteristics vary as a function of the speed of rotation, the energy released in the combustor, and work extracted by the turbines and supplied to compression or delivered to the external load. The first step in the Brayton cycle involves compressing the air entering the machine. This compression results in temperatures and pressures whose values are dictated by the type of machinery employed and physical laws well known to practitioners of the art. For example, it has been recognized for many years that low pressure ratio compressors result in temperatures entering the combustors that are too low for effective utilization of catalytic type combustion, or for effective vaporization of liquid fuels such as No. 2 diesel.

It will be appreciated, then, that the operation of a system may result in combustor inlet temperatures that are not suited to optimal operation of the combustor, whereby previous designs have involved significant trade-offs in operating efficiency. Therefore, it would be desirable to provide a more effective way of adapting a combustor to the operating conditions of a system.

Combustors themselves operate in many different ways. For example, some combustors incorporate regions separated physically or by fluid conditions to create zones of fuel-rich combustion followed by fuel-lean combustion, while others incorporate regions with fuel lean combustion followed by further fuel-lean operation. To further illustrate the complexity, note that for all types of combustors, fuel may be introduced separately into one or several zones of the combustor, or the fuel can be pre-mixed with air prior to combustion and then injected into the oxidizer prior to combustion, the same or separate zones of the combustor. It would be desirable to enable all types of combustors to operate more efficiently, and in the case of catalytic combustors to reduce the manufacturing cost thereof, especially by reducing the amount of catalytic material that is required.

### SUMMARY OF THE INVENTION

One aspect of the present invention relates to a method of producing energy wherein a turbine mechanism is driven and drives both a compressor mechanism and an energy generating device. The turbine mechanism is driven by the steps of:

A) conducting from the compressor a fluid flow including at least compressed air;

B) dividing the fluid flow into a plurality of fluid portions, the ratio of which being established by an adjustable valve mechanism;

C) conducting the first and second fluid portions to an inlet of a combustor through respective first and second flow paths and recombining the first and second fluid portions;

D) transferring heat from a combustion chamber of the combustor to the combustor inlet using the second fluid portion traveling through the second flow path as a heat transfer medium, wherein the second fluid portion reaching the inlet of the combustor is hotter than the first fluid portion;

E) combusting a fuel in the combustion chamber in the presence of compressed air from the first and second fluid portions; and

F) conducting products of combustion from the combustor to the turbine mechanism.

Preferably, step D comprises conducting the second fluid portion in heat exchange relationship with portions of the combustor combustion chamber. Alternatively, or additionally, step D can be performed by recirculating products of combustion from inside the combustion chamber back to the combustor inlet via the second flow path.

A further aspect of the invention involves a method of operating a catalytic combustor wherein compressed air and fuel is conducted into a combustion chamber of a catalytic combustor and through a catalytic body disposed in the combustion chamber. Some of the products of combustion are recycled back through the catalytic body.

Another aspect of the invention involves a catalytic combustor comprising a combustion chamber and a conduit. The combustion chamber includes an inlet region into which compressed air and fuel are introduced, and a catalytic body arranged to react with the introduced fuel and air to produce products of combustion. A conduit communicating with the products of combustion recycle some of those products back through the catalytic body.

Another aspect of the invention relates to a power generating system which comprises a compressor mechanism for compressing air, and a valve mechanism for splitting the compressed air into a plurality of fluid portions. A combustor is provided having an inlet and a combustion chamber. First and second fluid paths are provided for respectively conducting first and second ones of the fluid portions to the combustor inlet. The second fluid path is arranged for conducting the second fluid portion in heat exchanging relationship with portions of the combustion chamber to preheat the second fluid portion as the second fluid portion travels to the combustor inlet.

Preferably, the second fluid path communicates with a recirculation hole formed in the combustion chamber. An aspirating device is provided for aspirating products of combustion out of the combustion chamber through the recirculation hole, and into the second fluid path to be entrained in the second fluid portion.

Another aspect of the invention relates to a combustor for combusting fuel and compressed air. The combustor comprises an inlet, and a combustion chamber communicating with the inlet for combusting the fluid and compressed air. A path extends within the combustor and includes an entrance disposed downstream of the combustor inlet with reference to fluid flow through the combustion chamber, and an exit disposed at the combustor inlet, for conducting a flow of compressed fluid from the entrance to the exit in heat exchange relationship with portions of the combustion chamber.

Yet another aspect of the invention relates to a combustor for combusting fuel and compressed air. The combustor comprises an inlet, and a combustion chamber communicating with the inlet for conducting the fuel and compressed air. A first combustion zone is disposed within the combustion chamber for combusting part of the fuel and compressed air. A second combustion zone is disposed downstream of the first combustion zone for combusting fuel and compressed air not previously combusted. A recirculation passage is provided for conducting products of combustion out of the combustion chamber from a location between the first and second combustion zones and back to the combustor inlet.

### BRIEF DESCRIPTION OF THE DRAWING

The objects and advantages of the invention will become apparent from the following detailed description of preferred embodiments thereof in connection with the accompanying drawings in which like numerals designate like elements and in which:

FIG. 1 is a schematic view of an energy generating mechanism according to the present invention;

FIG. 2 is a schematic view of a combustor disposed in the system of FIG. 1 according to the present invention;

FIG. 2A is a front view of a disk disposed in the combustor depicted in FIG. 2;

FIG. 3 is a schematic view of a second embodiment of a combustor according to the invention;

FIG. 4 schematically depicts a third embodiment of a combustor according to the invention;

FIG. 5 schematically depicts a fourth embodiment of a combustor according to the present invention.

FIG. 6 depicts a side view of a fifth embodiment of a combustor according to the invention; and

FIG. 7 is a sectional view taken along the line VII-VII in FIG. 6.

### DETAILED DESCRIPTION OF PREFERRED EMBODIMENTS OF THE INVENTION

Depicted in FIG. 1 is an automated self-contained energy center which comprises a compressor/turbine spool 16, comprising a compressor 18 and an expansion turbine 20 interconnected by a shaft 22. During normal operating conditions, air is introduced into the compressor via main duct 24. Fuel, such as natural gas for example, is introduced via conduit 26 through the wall at the compressor mouth. The air and fuel are drawn separately into the compressor 18 where they are compressed and mixed, and the compressed air/fuel mixture exiting the compressor is then heated by being passed through the cold side of a heat exchanger 28, which can be of any suitable type, such as a recuperator or regenerator.

All turbines used herein are preferably conventional, most preferably turbines having a power output no greater than one megawatt.

The heated air/fuel mixture from the heat exchanger 28 is combusted in a combustor 30, which transforms the mixture into products of combustion having a temperature corresponding to the required operating temperature of the turbine inlet. The products of combustion are then expanded in the turbine 20. Exhaust gas from the turbine 20 is expanded in a power turbine 32 to which an electrical generator 23 is connected. Exhaust gas from the power turbine 32 is then conducted through the hot side of the heat exchanger in heat exchanger relationship with air/fuel mixture passing through the cold side of the heat exchanger 28. In order for self-sustained operation to result, the heating of the air/fuel mixture in the heat exchanger 28 must bring the air/fuel mixture to a threshold temperature necessary for oxidation to occur in the combustor 30.

If the combustor 30 is a catalytic combustor, then it will be appreciated that at the initiation of start-up, the catalytic combustor will be below its activation temperature. Accordingly, there is provided an electric heater 40, or any other suitable heat generator, which supplies heat to the catalytic combustor to rapidly bring it to its start-up temperature. A conventional heater for a catalytic combustor is disclosed in U.S. Pat. No. 4,065,917, the disclosure of which is incorporated herein by reference.

In the following description, a combustor of the catalytic type will be described, but it should be appreciated that the present invention is applicable to any other suitable type of combustor, such as lean-lean and diffusion flame types of combustors, for example.

The catalytic combustor 30 comprises an outer wall 50 forming a combustion chamber 52 in which front and rear disks 53, 54 are mounted. The front disk 53 has holes formed therein for receiving front ends of respective tubes 55, and the remainder of the front disk 53 is perforated at 57 to admit fluid flow. The rear disk 54 also possesses holes for receiving rear ends of respective ones of the tubes 55. The rest of the rear disk 54 is solid. The wall 50 forms an annular flow passage 56 extending around the combustion chamber adjacent the rear disk 54 for admitting a fluid flow into the combustion chamber. Thus, fluid flow entering the combustion chamber from the annular passage 56 flows toward and through the perforations 57 of the front disk and then into inlet ends of the tubes 55. Disposed in each tube is a catalyst body 58 formed for example of a precious metal catalyst deposited upon an aluminum oxide wash coat in turn deposited upon a corderite ceramic matrix. The tubes 55 thus define flow channels for conducting fluid into contact with the catalyst. The fluid is preferably a compressed air/fuel mixture conducted from the heat exchanger 28 to the combustor 30 by means of a conduit arrangement. The conduit arrangement includes an inflow section 78 communicating with first and second supply sections 72, 74 via a valve 76. The first supply section 72 constitutes part of a first flow path arranged for conducting a first portion of the compressed air/fuel mixture to a location 80 adjacent an inlet end 77 of the combustion chamber 52. The second supply section 74 constitutes part of a first flow path which conducts a second portion of the compressed air/fuel mixture to the fluid passage 56.

Thus, the second portion of the compressed air/fuel mixture initially travels through the combustion chamber 52 toward the front disk 53 and then in the opposite (counterflow) direction through the catalyst bodies 58, whereby the air/fuel mixture traveling toward the front disk 53 is preheated by the walls of the tubes 55.

Accordingly, when the second fluid portion eventually reaches the inlet end of the combustion chamber 77 and is combined with the first fluid portion that enters from the first supply section 72, the temperature of the combined first and second fluid portions will be higher than would otherwise have been the case if all fluid had traveled through the first supply section 72.

As will be appreciated, by controlling the design and construction parameters of the tubes 55, such as: (i) the length and/or diameter thereof, (ii) whether the outer surfaces of the tubes carry heat-exchange fins, or boundary layer trip ridges, and (iii) other parameters known to those skilled in the art, the amount of heat that is exchanged can be controlled, and the size of the combustor can be optimized.

The final temperature of the fluid stream entering the combustion chamber 52 can thus be controlled by regulation of the valve 76, i.e., by selectively varying the ratio of the first and second portions of the fluid stream traveling from the inflow section 78. For instance, the valve 76 can be connected to a controller so as to be activated in response to various sensed operating conditions, such as combustor inlet temperature, ambient temperature, external load on the system, etc. in order to adapt the operation of the combustor to those or other conditions. Since the valve 76 is disposed in a relatively cool fluid stream, it will not be subjected to high temperatures, and thus should exhibit a high degree of reliability.

It is not necessary for the combustor to be used in a system wherein the air and fuel are premixed prior to entry into the combustion chamber 52. Instead, the fuel could be introduced into the combustion chamber separately from the air.

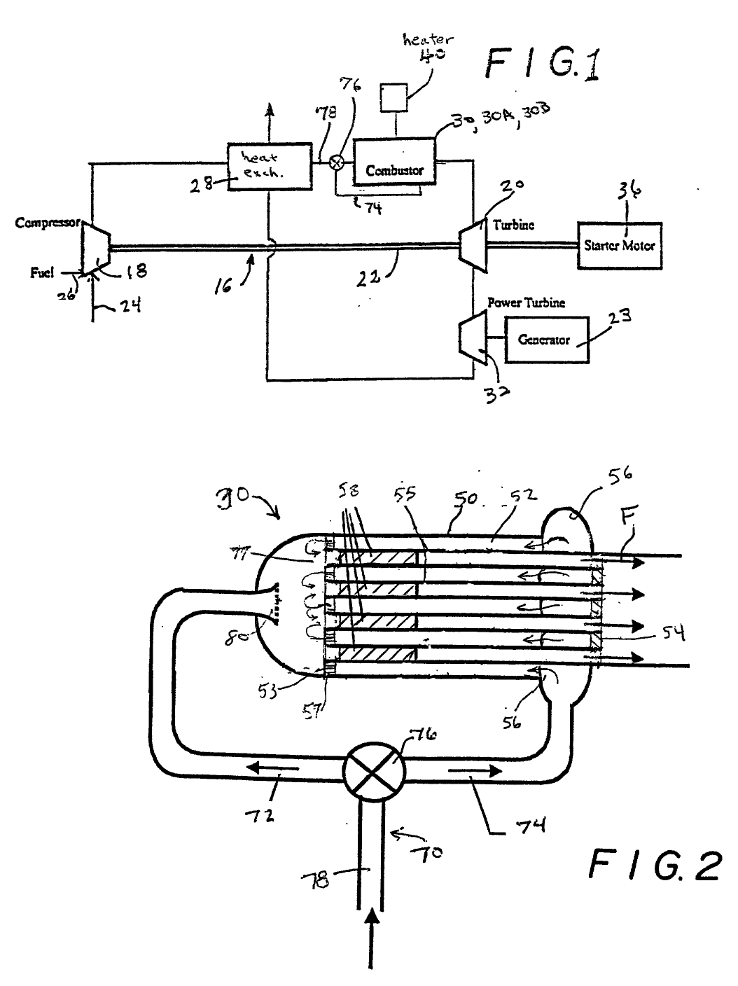

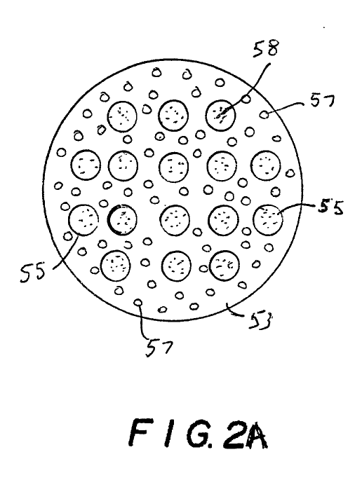

In the embodiment according to FIG. 2, there is only one combustion zone in the combustion chamber, i.e., the zone created by the set of catalyst bodies 58. In some cases, it may be desirable to provide more than one combustion zone spaced longitudinally apart along the direction of fluid flow F. For example, in order to prevent temperatures in the combustion chamber 52 from becoming too high, a second set of catalytic bodies could be situated in the combustion chamber 52 at a location downstream of (i.e. to the right of) the catalyst bodies 58. The first set of catalytic bodies 58 would be sized so that only a portion of the incoming air/fuel would be combusted thereby; the remainder would be combusted in the second set. As a result, lower temperatures would be generated in the first combustion zone to avoid damaging the tubes 55.

If the combustor were of a non-catalytic type, then there would be provided burners spaced apart along the direction of flow F, in lieu of spaced sets of catalyst bodies.

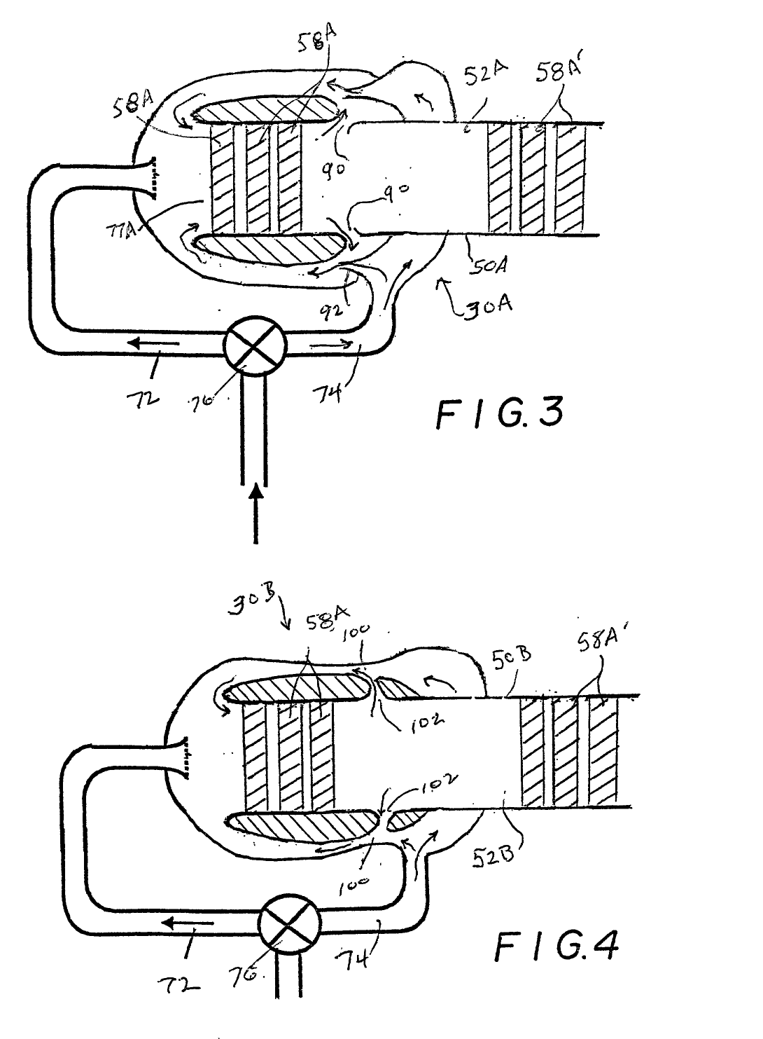

An arrangement of longitudinally spaced sets of catalyst bodies is depicted in the embodiment of a combustor 30A according to FIG. 3. However, in that embodiment, there occurs an additional advantageous step involving a direct transfer of heat back to the inlet of the combustion chamber, rather than the indirect transfer described in connection with FIG. 2. That is, products of combustion are removed from the combustion chamber between longitudinally spaced catalytic elements 58A, 58A′ which in this case, are in the form of longitudinally spaced circular disks, and are recirculated back to the inlet 77A of the combustion chamber 52A. The combustion chamber 52A is provided with one or more recirculation openings 90 in the outer wall 50A. A venturi eductor or ejector is provided for sucking products of combustion out of the combustion chamber through the recirculation openings 90. That eductor comprises one or more eductor passages 92 of small cross section which communicate with the conduit section 74 for aspirating products of combustion from the combustion chamber. Those aspirated products of combustion become entrained in the air flow and are conducted back to the inlet of the combustion chamber. The hot products of combustion will result in a heating of the flow supplied to the combustor inlet.

A somewhat similar arrangement is shown in the embodiment of a combustor 30B according to FIG. 4, except that the conduit section 74 communicates directly with a venturi tube 100 to suck the products of combustion through recirculation openings 102 formed in the outer wall 50B of the combustion chamber 52B.

By recirculating products of combustion to the inlet of the combustion chamber in accordance with the embodiments of FIGS. 3 and 4, two main benefits are realized. Firstly, the temperature at the inlet of the combustor inlet can be regulated in order to more closely adapt the combustor to the working conditions, as discussed earlier in connection with FIG. 2. Secondly, species which promote the combustion process, such as free radicals, may be present in the recirculated stream in addition to the physical heat content of the stream. These species can work synergistically with the physical heat content to more rapidly initiate combustion. This is especially true in the case where the combustor is of the catalytic type.

Of course, the products of combustion could be removed from the combustion chamber by mechanical devices such as pumps, fans and the like. However, such devices will be susceptible to damage from high heat, and require an external source of power, which increases costs and reduces reliability. On the other hand, the venturi-type arrangements according to FIGS. 3 and 4 which use the energy of compressed air or air/fuel mixture, have no moving parts and are highly efficient with little risk of heat-induced damage. While the preferred embodiment of the present invention is in a thermodynamic cycle, and particularly a continuous Brayton cycle, it will be appreciated by those skilled in the art that it is applicable to all cycles, processes, etc. where control of the inlet temperature of the combustor is necessary.

FIG. 5 depicts another embodiment of a structure for recycling products of combustion. In that embodiment, compressed air and fuel are conducted along a conduit 110 which includes a venturi 112. The venturi 112 communicates with the interior of the catalytic combustor 114 by means of a duct 116, whereby the suction generated in the venturi due to the passage of the compressed air and fuel sucks some products of combustion out of the combustion chamber from between the catalytic bodies 58B, 58B′ and recycles them back through the catalytic bodies 58B.

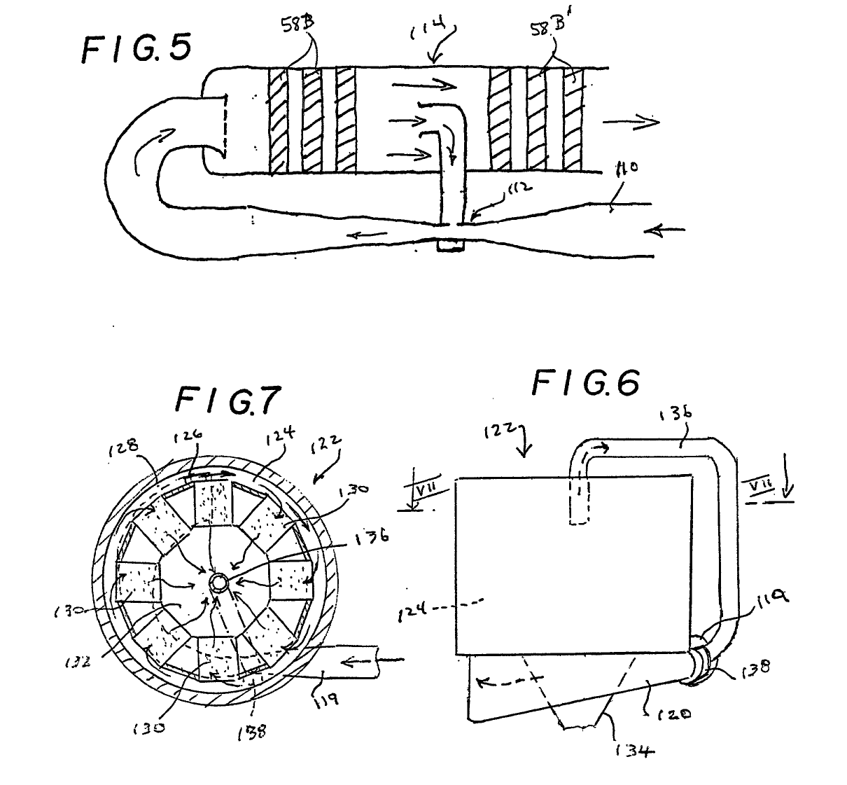

Still another structure for recycling products of combustion is depicted in FIGS. 6 and 7. In that embodiment, compressed air and fuel is introduced into the inlet of an expansion duct 120 of a catalytic combustor 122 from a supply conduit 119. The expansion duct is arranged tangentially with respect to a cylindrical combustion chamber 124 disposed thereabove. The air/fuel mixture exits upwardly from the expansion duct and passes through a hole 126 formal in a floor 128 of the combustion chamber. Thus, the mixture enters the combustion chamber in a generally tangential direction and flows in a circular path around the outside of a circular array of catalyst bodies 130 disposed in the combustion chamber (eight such bodies being depicted). Portions of the flowing mixtures pass radially inwardly through respective ones of the catalyst bodies 130 and, upon exiting the catalyst bodies, enter a center area 132 of the reaction chamber.

Most of the products of combustion are discharged from that center area 132 in an axially downward direction via conduit 134 and conducted to a turbine. A recycling conduit 136 extending from the center area 132 to the inlet of the expansion duct, conducts some of the products of combustion to the inlet to be combined with the incoming air/fuel mixture. The inlet is in the form of a venturi 138, whereby the incoming air/fuel flow would suck-in the products of combustion from the recycling conduit.

In accordance with the embodiments of the invention disclosed in connection with FIGS. 2-4, the inlet temperature of the combustor can be more readily adapted to the operating conditions of the system by actuating the valve 76 to vary the amount of heat that is recirculated back to the combustor inlet, either directly or indirectly. Furthermore, in each of the disclosed embodiments, the combustion action within the combustion chamber can be considerably improved by recirculating products of combustion back to the combustor inlet (direct recirculation). That recirculation can be accomplished using compressed air or air/fuel mixture, thereby avoiding the use of devices that have moving parts and that are susceptible to damage by high temperatures.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A method of producing energy wherein a turbine mechanism is driven and drives both a compressor mechanism and an energy generating device, the turbine mechanism being driven by the steps of:
A) conducting from the compressor a fluid flow including at least compressed air;
B) dividing the fluid flow into a plurality of fluid portions, the ratio of which being established by an adjustable valve mechanism;
C) conducting the first and second fluid portions to an inlet of a combustor through respective first and second flow paths and recombining the first and second fluid portions;
D) transferring heat from a combustion chamber of the combustor to the combustor inlet using the second fluid portion traveling in the second flow path as a heat transfer medium, wherein the second fluid portion reaching the inlet of the combustor is hotter than the first fluid portion reaching the inlet of the combustor;
E) combusting a fuel in the combustion chamber in the presence of compressed air from the first and second fluid portions; and
F) conducting products of combustion from the combustor to the turbine mechanism.

2. The method according to claim 1 wherein step D comprises conducting the second fluid portion through a second flow path disposed within the combustor.

3. The method according to claim 2 wherein the combustion chamber of step E comprises first and second combustion zones spaced apart in a direction of fluid flow through the combustion chamber, and step E comprises combusting only some of the compressed air and fuel in the first combustion zone, combusting remaining compressed air and fuel in the second combustion zone, and recirculating products of combustion from a location between the first and second combustion zones back to the combustor inlet.

4. The method according to claim 3 wherein the recirculating step is performed by using the second fluid portion to suck products of combustion out of the combustion chamber.

5. The method according to claim 3 further comprising the step of adjusting the valve mechanism to vary the ratio of the first and second fluid portions in accordance with selected sensed operating conditions.

6. The method according to claim 2 further comprising the step of adjusting the valve mechanism to vary the ratio of the first and second fluid portions in accordance with selected sensed operating conditions.

7. The method according to claim 1 wherein the combustion chamber of step E comprises first and second combustion zones spaced apart in a direction of fluid flow through the combustion chamber, and step E comprises combusting only some of the compressed air and fuel in the first combustion zone, combusting remaining compressed air and fuel in the second combustion zone, and recirculating products of combustion from a location between the first and second combustion zones back to the combustor inlet.

8. The method according to claim 7 wherein combustion in each of the combustion zones is performed by a catalyst.

9. The method according to claim 7 wherein the recirculating step is performed by using the second fluid portion to suck products of combustion out of the combustion chamber.

10. The method according to claim 1 further comprising the step of adjusting the valve mechanism to vary the ratio of the first and second fluid portions in accordance with selected sensed operating conditions.

11. The method according to claim 1 wherein the fluid flow of step A is formed by compressing a mixture of fuel and air.

12. A method of operating an energy generating system having a compressor mechanism and a turbine mechanism, the method comprising the steps of:
A) operating the compressor mechanism to compress an air/fuel mixture;
B) conducting the compressed air/fuel mixture to a valve mechanism for dividing the compressed air/fuel mixture into first and second fluid portions, respectively;
C) conducting the first fluid portion to an inlet of a combustion chamber;
D) conducting the second fluid portion in heat exchanging relationship with portions of the combustion chamber to preheat the second fluid portion;
E) delivering the preheated second fluid portion to the inlet of the combustion chamber;
F) combusting the first and second fluid portions in the combustion chamber;
G) operating the turbine mechanisms by products of combustion from the combustion chamber;
H) employing the turbine mechanism to operate the compressor mechanism and an energy producing device; and
I) adjusting the valve mechanism to vary the ratio of the first and second fluid portions in response to selected sensed operating conditions.

13. The method according to claim 12 wherein the combustion chamber of step F comprises first and second combustion zones, and step F comprises combusting only some of the compressed air and fuel in the first combustion zone, combusting remaining compressed air and fuel in the second combustion zone, and recirculating products of combustion from a location between the first and second combustion zones back to the combustor inlet of the first combustion zone.

14. The method according to claim 13 wherein the recirculating step is performed by using the second fluid portion to suck products of combustion from the location between the first and second combustion zones.

15. A method of operating a catalytic combustor comprising conducting a compressed air and fuel into a combustion chamber of the combustor and through a catalytic body disposed within the combustion chamber, and recycling some of the products of combustion resulting from a reaction between the catalytic body and the air and fuel back through the catalytic body.

16. A power generating system comprising:
a compressor mechanism for compressing air;
a valve mechanism for splitting the compressed air into a plurality of fluid portions;
a combustor having an inlet and a combustion chamber; and
first and second fluid paths for respectively conducting first and second ones of the fluid portions to the combustor inlet;
the second fluid path arranged for conducting the second fluid portion in heat exchange relationship with the combustion chamber to preheat the second fluid portion as the second fluid portion travels to the combustor inlet.

17. A power generating system comprising:
a compressor mechanism for compressing air;
a valve mechanism for splitting the compressed air into a plurality of fluid portions;
first and second fluid paths for respectively conducting first and second ones of the fluid portions to the combustor inlet, the second fluid path communicating with a recirculation hole communicating with the combustion chamber; and
aspirating means for aspirating products of combustion out of the combustion chamber through the recirculation hole, and into the second fluid path to be entrained in the second fluid portion.

18. The power generating system according to claim 17 wherein the aspirating means comprises a venturi structure disposed in the second fluid path.

19. A catalytic combustor for combusting fuel and compress air, comprising:
a combustion chamber including an inlet region into which compressed air and fuel are introduced, and a catalytic body arranged to react with the introduced air and fuel to produce products of combinations; and
a recycle conduit communicating with the product of combustion for recycling some of the products of combustion back to the inlet region.

20. A combustor according to claim 19, further including a venturi arranged to conduct the compressed air and fuel prior to introduction thereof into the combustion chamber the venturi communicating with the recycle conduit for sucking products of combustion into the conduit in response to a vacuum generated in the recycle conduit by compressed air and fuel passing through the venturi.

21. The combustor according to claim 20, wherein there is a plurality of the catalytic bodies arranged in a generally annular pattern, the compressed air and fuel being introduced generally tangentially into the combustion chamber and flowing generally radially through respective ones of the catalytic body and being converted to products of combustion collecting in a center region of the combustion chamber, the recycle conduit communicating with the center region.

22. The combustor according to claim 21 further including an expansion duct for receiving compressed air and fuel and conducting the compressed air and fuel into the combustion chamber in a generally tangential direction.

23. A combustor for combusting fuel and compressed air comprising:
an inlet;
a combustion chamber communicating with the inlet for combusting the fuel and component air; and
a path extending with the combustion chamber and including an entrance disposed downstream of the combustor inlet, and an exit at the combustor inlet with reference to a direction of flow through the combustion chamber, for conducting a flow of compressed fluid from the entrance to the exit in heat exchange relationship with products of combustion in the combustion chamber.

24. A combustor for combusting fuel and compressed air, comprising:
an inlet;
a combustion chamber communicating with the inlet for conducting the fuel and compressed air;
a first combustion zone disposed within the combustion chamber for combusting part of the fuel and compressed air;
a second combustion zone disposed downstream of the first combustion zone for combusting fuel and compressed air not previously combusted; and
a recirculation path for conducting products of combustion out of the combustion chamber from a location between the first and second combustion zones and back to the combustor inlet.

25. The combustor according to claim 24 further comprising a suction device arranged to suck the products of combustion from the combustion chamber and into the recirculation passage.

26. The combustor according to claim 25 wherein the suction device comprises a venturi structure disposed in the recirculation path and adapted to use a pressurized fluid flow for suck out the products of combustion.
